(19) United States
(12) Patent Application Publication
(10) Pub. No.: US 2024/0343639 A1
(43) Pub. Date: Oct. 17, 2024

(54) METHOD FOR MANUFACTURING CHEMICALLY TEMPERED GLASS MIRRORS

(71) Applicant: Weifang Hongmao Furniture Co., Ltd, Weifang (CN)

(72) Inventor: Xiaolong Li, Weifang (CN)

(21) Appl. No.: 18/305,756

(22) Filed: Apr. 24, 2023

(30) Foreign Application Priority Data
Apr. 14, 2023 (CN) 202310397802X

(51) Int. Cl. C03C 21/00; C03C 17/34

(52) U.S. Cl. CPC C03C 21/002; C03C 17/34; C03C 2218/156; C03C 2218/31

(57) ABSTRACT

A method for manufacturing chemically tempered glass mirrors by first processing chemical treatment and then mirror coating process, increases the strength and toughness of the glass without the problem of glass distortions. The invention provides high practicality and functionality, with a wide range of applications in the technical field of household products.

### 1. TECHNICAL FIELD

The invention relates to the technical field of household products, in particular to a method for manufacturing chemically tempered glass mirrors.

### 2. BACKGROUND ART

In the prior arts, one kind of mirror is made of ordinary glass coated with aluminum or silver, with the defect of easy breakage; the other kind of mirror is made of physically tempered glass coated with aluminum or silver, with increases of strength but the defect of image distortions. The patent with publication number No. CN104371455A discloses a color mirror and the manufacturing processes thereof, which has the advantages of various bright colors and high reflectivity with low cost, simple manufacturing process and reliable product quality, and can be manufactured industrially with a broad market prospect to fill the gap of the current market. However, the above disclosure has the drawback of failing to improve the imaging effect and enhance the damage resistance, which has certain technical defects.

### 3. SUMMARY OF THE INVENTION

In response to the above problems, the invention provides a method for manufacturing chemically tempered glass mirrors without the problems of easy breakage and imaging distortion.

The invention has the following technical solutions:

A method for manufacturing chemically tempered glass mirrors comprises the following steps:

S1. Processing the inspection, cutting, edge-grinding and cleaning of the original glass sheet, and the glass is in a pending state to be processed.

S2. Placing the glass to be processed in a preheating furnace, gradually heating the glass from the room temperature state to 380-450° C., and then immersing the glass in high-temperature molten salt at 380-450° C. for 4-10 hours.

S3. With the exchange of lithium-ions in the glass with potassium or sodium ions in solution and the exchange of sodium ions in the glass with potassium ions in solution, utilizing the volume difference of alkali ions to form a compressive stress layer on the surface of the glass, thus improving the strength of the glass without the problem of glass distortions.

S4. Coating red back paint and then coating another layer of black back paint after coating the treated glass with magnetron sputtering technology, thus completing the mirror coating process.

Preferably, the heating time for heating the glass from the room temperature state to 380-450° C. in S2 is 3 hours.

Compared to the prior arts, the invention has the following beneficial effects:

The method for manufacturing chemically tempered glass mirrors by first processing chemical treatment and then the mirror coating process, increases the strength and toughness of the glass without the problem of glass distortions.

The method provided in the invention also achieves a reduction in mirror weight and saves on packaging and shipping costs.

### 4. SPECIFIC EMBODIMENT OF THE INVENTION

To make the technical solutions provided by the invention more comprehensible, the invention is described below in further detail with reference to the embodiments.

The invention provides a technique for the mirror manufacturing method aimed at the tempered glass.

A method for manufacturing chemically tempered glass mirrors comprises the following steps:

S1. Processing the inspection, cutting, edge-grinding and cleaning of the original glass sheet, and the glass is in a pending state to be processed.

S2. Placing the glass to be processed in a preheating furnace, gradually heating the glass from the room temperature state to 380-450° C., and then immersing the glass in high-temperature molten salt at 380-450° C. for 4-10 hours.

S3. With the exchange of lithium-ions in the glass with potassium or sodium ions in solution and the exchange of sodium ions in the glass with potassium ions in solution, utilizing the volume difference of alkali ions to form a compressive stress layer on the surface of the glass, thus improving the strength of the glass without the problem of glass distortions.

S4. Coating red back paint and then coating another layer of black back paint after coating the treated glass with magnetron sputtering technology, thus completing the mirror coating process.

The heating time for heating the glass from the room temperature state to 380-450° C. in

S2 is 3 hours.

The invention is described below in further detail with reference to the embodiments.

### Embodiment 1

A method for manufacturing chemically tempered glass mirrors comprises the following steps:

S1. Processing the inspection, cutting, edge-grinding and cleaning of the original glass sheet, and the glass is in a pending state to be processed.

S2. Placing the glass to be processed in a preheating furnace, gradually heating the glass from the room temperature state to 380° C., and then immersing the glass in high-temperature molten salt at 380° C. for 4 hours.

S3. With the exchange of lithium-ions in the glass with potassium or sodium ions in solution and the exchange of sodium ions in the glass with potassium ions in solution, utilizing the volume difference of alkali ions to form a compressive stress layer on the surface of the glass, thus improving the strength of the glass without the problem of glass distortions.

S4. Coating red back paint and then coating another layer of black back paint after coating the treated glass with magnetron sputtering technology, thus completing the mirror coating process.

The heating time for heating the glass from the room temperature state to 380° C. in S2 is 3 hours.

### Embodiment 2

A method for manufacturing chemically tempered glass mirrors comprises the following steps:

S1. Processing the inspection, cutting, edge-grinding and cleaning of the original glass sheet, and the glass is in a pending state to be processed.

S2. Placing the glass to be processed in a preheating furnace, gradually heating the glass from the room temperature state to 450° C., and then immersing the glass in high-temperature molten salt at 450° C. for 10 hours.

S3. With the exchange of lithium-ions in the glass with potassium or sodium ions in solution and the exchange of sodium ions in the glass with potassium ions in solution, utilizing the volume difference of alkali ions to form a compressive stress layer on the surface of the glass, thus improving the strength of the glass without the problem of glass distortions.

S4. Coating red back paint and then coating another layer of black back paint after coating the treated glass with magnetron sputtering technology, thus completing the mirror coating process.

The heating time for heating the glass from the room temperature state to 450° C. in S2 is 3 hours.

### Embodiment 3

A method for manufacturing chemically tempered glass mirrors comprises the following steps:

S1. Processing the inspection, cutting, edge-grinding and cleaning of the original glass sheet, and the glass is in a pending state to be processed.

S2. Placing the glass to be processed in a preheating furnace, gradually heating the glass from the room temperature state to 400° C., and then immersing the glass in high-temperature molten salt at 400° C. for 7 hours.

S3. With the exchange of lithium-ions in the glass with potassium or sodium ions in solution and the exchange of sodium ions in the glass with potassium ions in solution, utilizing the volume difference of alkali ions to form a compressive stress layer on the surface of the glass, thus improving the strength of the glass without the problem of glass distortions.

S4. Coating red back paint and then coating another layer of black back paint after coating the treated glass with magnetron sputtering technology, thus completing the mirror coating process.

The heating time for heating the glass from the room temperature state to 400° C. in S2 is 3 hours.

### Embodiment 4

In this embodiment, the performance of the glass produced by the invention is compared with that of the glass produced by the method in the prior art.

The 2 mm thick glass produced by the invention is compared with the glass produced by the method in the prior art, from two indicators of imaging distortion degree and the fragility for comparison, respectively.

In conclusion, it is observed that the glass produced by the method provided by the invention has a better imaging effect; by artificially hitting or dropping the glass from the same height to determine the resistance capacity of hitting or bumping, it can be illustrated from several experiment results that the glass produced by the method provided by the invention is less damaged after being hit or dropped from a height.

### Embodiment 5

In this embodiment, the glass produced by the method provided by the invention is compared with the glass in the prior art in terms of weight of the same volume. The more specific method is as follows: the glass with specifications of 1 m×0.5 m×2 mm in length, width and thickness are cut out respectively to be weighed separately afterward, and it is clear from the comparison that the glass produced by the method provided by the invention has a lighter unit weight.

Therefore, the application of the method provided by the invention can reduce the breakage degree and improve imaging distortion, achieve a reduction in mirror weight and saves on packaging and shipping costs.

1. A method for manufacturing chemically tempered glass mirrors, wherein comprises the following steps:
S1. Processing the inspection, cutting, edge-grinding and cleaning of the original glass sheet, and the glass is in a pending state to be processed.
S2. Placing the glass to be processed in a preheating furnace, gradually heating the glass from the room temperature state to 380-450° C., and then immersing the glass in high-temperature molten salt at 380-450° C. for 4-10 hours.
S3. With the exchange of lithium-ions in the glass with potassium or sodium ions in solution and the exchange of sodium ions in the glass with potassium ions in solution, utilizing the volume difference of alkali ions to form a compressive stress layer on the surface of the glass, thus improving the strength of the glass without the problem of glass distortions.
S4. Coating red back paint and then coating another layer of black back paint after coating the treated glass with magnetron sputtering technology, thus completing the mirror coating process.

2. A method for manufacturing chemically tempered glass mirrors according to claim 1, wherein the heating time for heating the glass from the room temperature state to 380-450° C. in S2 is 3 hours.
